(19) United States
(12) Patent Application Publication
(10) Pub. No.: US 2021/0253943 A1
(43) Pub. Date: Aug. 19, 2021

(54) DOWNHOLE TREATMENT COMPOSITIONS COMPRISING CELLULOSE ESTER BASED DEGRADABLE DIVERTING AGENTS AND METHODS OF USE IN DOWNHOLE FORMATIONS

(71) Applicant: Eastman Chemical Company, Kingsport, TN (US)

(72) Inventors: Koushik Ghosh, Albuquerque, NM (US); Ronald Buford Sheppard, Kingsport, TN (US)

(73) Assignee: Eastman Chemical Company, Kingsport, TN (US)

(21) Appl. No.: 16/973,096

(22) PCT Filed: May 29, 2019
(86) PCT No.: PCT/US2019/034242

§ 371 Date: Dec. 8, 2020

Related U.S. Application Data
(60) Provisional application No. 62/685,560, filed on Jun. 15, 2018.

(51) Int. Cl. C09K 8/80; C09K 8/90

(52) U.S. Cl. CPC C09K 8/80; C09K 8/90

(57) ABSTRACT

Degradable particulate materials are provided that may be utilized in various downhole treatment fluids, such as hydraulic fracturing fluids. In particular, the degradable particulate materials can be formed from cellulose esters that are capable of effectively degrading at specific rates when exposed to the aqueous environments in high temperature wells 149 to 250° C.).

### FIELD OF THE INVENTION

The present invention relates to downhole treatment fluids comprising cellulosic degradable diverting agents and methods of using the downhole treatment fluids in downhole or subterranean formations.

### BACKGROUND OF THE INVENTION

Hydrocarbon-producing wells are often stimulated by hydraulic fracturing operations, wherein a downhole or wellbore treatment fluid may be introduced into a portion of a downhole formation penetrated by a well bore at a hydraulic pressure sufficient to create or enhance at least one fracture therein. Often, particulate solids, such as graded sand, will be suspended in a portion of the wellbore treatment fluid so that the proppant particles may be placed in the resultant fractures to maintain the integrity of the fractures (after the hydraulic pressure is released), thereby forming conductive channels within the formation through which hydrocarbons can flow. Once at least one fracture has been created and at least a portion of the proppant is substantially in place within the fracture, the viscosity of the wellbore treatment fluid may be reduced to facilitate removal of the wellbore treatment fluid from the formation.

In certain hydrocarbon-producing formations, much of the production may be derived from natural fractures. These natural fractures may exist in the reservoir prior to a fracturing operation, and, when contacted by an induced fracture (e.g., a fracture formed or enhanced during a fracturing treatment), may provide flow channels having a relatively high conductivity that may improve hydrocarbon production from the reservoir. However, fracturing treatments often may be problematic in naturally-fractured reservoirs, or in any other reservoirs where an existing fracture could intersect a created or enhanced fracture. In such situations, the intersection of the fractures could impart a highly tortuous shape to the created or enhanced fracture, which could result in, e.g., premature screenout. Additionally, the initiation of a fracturing treatment on a well bore intersected with multiple natural fractures may cause multiple fractures to be initiated, each having a relatively short length, which also could cause undesirable premature screenouts.

In an attempt to address these problems, wellbore treatment fluids are often formulated to include diverting agents that may, inter alia, form a temporary plug in the perforations or natural fractures that tend to accept the greatest fluid flow, thereby diverting the remaining wellbore treatment fluid to the generated fracture. However, conventional diverting agents may be difficult to remove completely from the downhole formation, which may cause a residue to remain in the well bore area following the fracturing operation, which may permanently reduce the permeability of the formation. In some cases, difficulty in removing conventional diverting agents from the formation may permanently reduce the permeability of the formation by between 5% to 40%, and may even cause a 100% permanent reduction in permeability in some instances. This situation can be remedied by using degradable diverting agents that dissolve, disperse, or breakdown in the downhole wells. Therefore, there is a need for new degradable diverting agents.

### SUMMARY OF THE INVENTION

The present application discloses a downhole well treatment composition comprising:

(1) a first solid particulate, comprising a first degradable material; and

(2) a base fluid,
wherein the first solid particulate has a first graded particle size in the range of from about 4 to about 8 U.S. Standard Mesh,
wherein the first solid particulate exhibits a percent weight loss of not more than about 20 percent (20%) after 4 hours at a temperature in the range of from 127° C. to 250° C. in deionized water,
wherein the first degradable material is a first cellulose ester comprising a plurality of (C₁₋₆)alkyl-CO— substituents, wherein the degree of substitution of the (C₁₋₆)alkyl-CO— substituents is in the range of from about 1.7 to about 3.0.
   The present application also discloses methods of using the downhole well treatment compositions.

The features and advantages will be readily apparent to those skilled in the art upon a reading of the description.

### DETAILED DESCRIPTION

As used herein, the terms “a,” “an,” and “the” mean one or more.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Degradable as used herein means that a material is capable of dissolving, dispersing, breaking down, or chemically deteriorating. The degradation can occur by bulk erosion and surface erosion, and any stage of degradation in between these two. Degradation can occur by chemical reactions in the downhole well with water or other chemicals. The degradation can also occur by intramolecular chemical reactions. The degradable material disclosed in this application degrade by first dissolving or dispersing in the downhole well. Once dissolved or dispersed, further chemical reactions may occur in the downhole formation to break down the degradable material into smaller molecules.

“Diverter” or “diverting agent” means anything used in a well to cause something to turn or flow in a different direction, e.g., a diversion material or mechanical device; a Solid or fluid that may plug or fill, either partially or fully, a portion of a downhole formation.

“Fracture” means a crack or surface of breakage within rock.

“Proppant” are typically granular materials such as sand, ceramic beads, and other materials. Proppants are typically used to hold fractures open after pressures are reduced.

As used herein the term “chosen from” used with the terms “and’ or “or when used in a list of two or more items, means that any one of the listed items can be employed by itself in the case of “chosen from” in conjunction with “and,” or means that any one of the listed items can be employed by itself or in any combination in the case of “chosen from” in conjunction with “or”, or any combination of two or more of the listed items can be employed. For example, if a composition is described as chosen from A, B, and C, the composition can contain A alone; B alone; or C alone. For example, if a composition is described as chosen from A, B, or C, the composition can contain A alone; B alone; C alone; A and B in combination; A and C in combination; B and C in combination; or A, B, and C in combination.

The downhole treatment composition, disclosed herein, is suitable for use in, inter alia, hydraulic fracturing and frac-packing applications. The downhole treatment composition may be flowed through a downhole formation as part of a downhole operation (e.g., hydraulic fracturing), and the first solid particulate described herein may bridge or obstruct pore throats in smaller fractures that may be perpendicular to the one or more dominant factures being formed in the formation. Among other things, this may provide additional flow capacity that may facilitate extending one or more dominant fractures in the formation. The first solid particulate described herein may facilitate increased hydrocarbon production from the formation after the conclusion of the treatment operation, inter alia, because the dissolution or dispersion of the first solid particulate may enhance flow of hydrocarbons from the formation into the one or more dominant fractures, from which point the hydrocarbons may flow to the well bore and then to the surface, where they may be produced.

The rate of degradation of degradable materials depends on a number of physical and chemical factors of both the degradable material and the environment around the degradable material. Physical factors of the degradable material that may affect its degradation rate include, for example, shape, dimensions, roughness, and porosity. Physical factors of the environment that may affect degradation rate include, for example, temperature, pressure, and agitation. The relative chemical make-up of the degradable material and the environment within which it is placed can greatly influence the rate of degradation of the material.

In one embodiment, the first solid particulate exhibits a percent weight loss of not more than two percent (2%) after 4 hours at the temperature range of from 127° C. to 250° C. in deionized water. In one class of this embodiment, the first solid particulate exhibits a percent weight loss of not less than sixty-five percent (65%) after 189 hours at a temperature in the range of from 127° C. to 250° C. in deionized water. In one class of this embodiment, the first solid particulate exhibits a percent weight loss of not less than seventy-five percent (75%) after 189 hours at a temperature in the range of from 127° C. to 250° C. in deionized water.

In one embodiment, the first solid particulate exhibits a percent weight loss of not more than five percent (5%) after 4 hours at the temperature range of from 127° C. to 250° C. in deionized water. In one class of this embodiment, the first solid particulate exhibits a percent weight loss of not less than sixty-five percent (65%) after 189 hours at a temperature in the range of from 127° C. to 250° C. in deionized water. In one class of this embodiment, the first solid particulate exhibits a percent weight loss of not less than seventy-five percent (75%) after 189 hours at a temperature in the range of from 127° C. to 250° C. in deionized water.

In one embodiment, the first solid particulate exhibits a percent weight loss of not more than eight percent (8%) after 4 hours at the temperature range of from 127° C. to 250° C. in deionized water. In one class of this embodiment, the first solid particulate exhibits a percent weight loss of not less than sixty-five percent (65%) after 189 hours at a temperature in the range of from 127° C. to 250° C. in deionized water. In one class of this embodiment, the first solid particulate exhibits a percent weight loss of not less than seventy-five percent (75%) after 189 hours at a temperature in the range of from 127° C. to 250° C. in deionized water.

In one embodiment, the first solid particulate exhibits a percent weight loss of not more than ten percent (10%) after 4 hours at the temperature range of from 127° C. to 250° C. in deionized water. In one class of this embodiment, the first solid particulate exhibits a percent weight loss of not less than sixty-five percent (65%) after 189 hours at a temperature in the range of from 127° C. to 250° C. in deionized water. In one class of this embodiment, the first solid particulate exhibits a percent weight loss of not less than seventy-five percent (75%) after 189 hours at a temperature in the range of from 127° C. to 250° C. in deionized water.

In one embodiment, the first solid particulate exhibits a percent weight loss of not more than fifteen percent (15%) after 4 hours at the temperature range of from 127° C. to 250° C. in deionized water. In one class of this embodiment, the first solid particulate exhibits a percent weight loss of not less than sixty-five percent (65%) after 189 hours at a temperature in the range of from 127° C. to 250° C. in deionized water. In one class of this embodiment, the first solid particulate exhibits a percent weight loss of not less than seventy-five percent (75%) after 189 hours at a temperature in the range of from 127° C. to 250° C. in deionized water.

In one embodiment, the first solid particulate exhibits a percent weight loss of not more than two percent (2%) after 8 hours at the temperature range of from 127° C. to 250° C. in deionized water. In one embodiment, the first solid particulate exhibits a percent weight loss of not more than five percent (5%) after 8 hours at the temperature range of from 127° C. to 250° C. in deionized water. In one embodiment, the first solid particulate exhibits a percent weight loss of not more than eight percent (8%) after 8 hours at 204° C. in deionized water. In one embodiment, the first solid particulate exhibits a percent weight loss of not more than ten percent (10%) after 8 hours at the temperature range of from 127° C. to 250° C. in deionized water. In one embodiment, the first solid particulate exhibits a percent weight loss of not more than fifteen percent (15%) after 8 hours at the temperature range of from 127° C. to 250° C. in deionized water.

In one embodiment, the first solid particulate exhibits a percent weight loss of not less than ninety-five percent (95%) after 189 hours at a temperature in the range of from 127° C. to 250° C. in deionized water. In one embodiment, the first solid particulate exhibits a percent weight loss of not less than ninety percent (90%) after 189 hours at a temperature in the range of from 127° C. to 250° C. in deionized water. In one embodiment, the first solid particulate exhibits a percent weight loss of not less than eighty-five percent (85%) after 189 hours at a temperature in the range of from 127° C. to 250° C. in deionized water. In one embodiment, the first solid particulate exhibits a percent weight loss of not less than eighty percent (80%) after 189 hours at a temperature in the range of from 127° C. to 250° C. in deionized water. In one embodiment, the first solid particulate exhibits a percent weight loss of not less than seventy-five percent (75%) after 189 hours at a temperature in the range of from 127° C. to 250° C. in deionized water. In one embodiment, the first solid particulate exhibits a percent weight loss of not less than seventy percent (70%) after 189 hours at a temperature in the range of from 127° C. to 250° C. in deionized water. In one embodiment, the first solid particulate exhibits a percent weight loss of not less than sixty-five percent (65%) after 189 hours at a temperature in the range of from 127° C. to 250° C. in deionized water. In one embodiment, the first solid particulate exhibits a percent weight loss of not less than sixty percent (60%) after 189 hours at a temperature in the range of from 127° C. to 250° C. in deionized water. In one embodiment, the first solid particulate exhibits a percent weight loss of not less than fifty percent (50%) after 189 hours at a temperature in the range of from 127° C. to 250° C. in deionized water. In one embodiment, the first solid particulate exhibits a percent weight loss of not less than forty-five percent (45%) after 189 hours at a temperature in the range of from 127° C. to 250° C. in deionized water. In one embodiment, the first solid particulate exhibits a percent weight loss of not less than forty percent (40%) after 189 hours at a temperature in the range of from 127° C. to 250° C. in deionized water.

The specific features of the solid particulates disclosed in the present application may be modified so as to prevent loss of fluid to the formation. The solid particulates may have any shape, including, but not limited to, particles having the physical shape of platelets, shavings, flakes, ribbons, rods, strips, spheroids, toroids, pellets, tablets, fibers, or any other physical shape. One of ordinary skill in the art, with the benefit of this disclosure, will recognize the specific degradable material that may be used in the degradable diverting agents, and the preferred size and shape for a given application.

A variety of base fluids may be included in the treatment fluids used in the methods of the present invention. For example, the base fluid may comprise water, acids, oils, or mixtures thereof. In certain embodiments of the present invention wherein the base fluid comprises water, the water used may be freshwater, salt water (e.g., water containing one or more salts dissolved therein), brine (e.g., saturated salt water), or seawater. Generally, the water may be from any source, provided that it does not contain an excess of compounds that may adversely affect other components in the downhole treatment composition. Examples of suitable acids include, but are not limited to, hydrochloric acid, acetic acid, formic acid, citric acid, or mixtures thereof. In certain embodiments, the base fluid may further comprise a gas (e.g., nitrogen, or carbon dioxide). Generally, the base fluid is present in the downhole treatment composition in an amount in the range of from about 25% to about 99% by weight of the downhole treatment composition.

In one embodiment, the base fluid is present in the downhole treatment composition in the range of from about 70 to 99 weight percent based on the total weight of the downhole treatment composition. In one embodiment, the base fluid is present in the downhole treatment composition in the range of from about 70 to 80 weight percent based on the total weight of the downhole treatment composition. In one class of this embodiment, the base fluid is present in the downhole treatment composition in the range of from about 80 to 99.9 weight percent based on the total weight of the downhole treatment composition. In one class of this embodiment, the base fluid is present in the downhole treatment composition in the range of from about 80 to 99 weight percent based on the total weight of the downhole treatment composition. In one class of this embodiment, the base fluid is present in the downhole treatment composition in the range of from about 80 to 90 weight percent based on the total weight of the downhole treatment composition. In one class of this embodiment, the base fluid is present in the downhole treatment composition in the range of from about 90 to 99 weight percent based on the total weight of the downhole treatment composition.

The first solid particulate may be present in the downhole treatment composition in an amount sufficient to provide a desired amount of fluid loss control. In one embodiment, the first solid particulate is present in the downhole treatment composition in the range of from about 0.1 wt % to about 20 wt %. In one embodiment, the first solid particulate is present in the downhole treatment composition in the range of from about 0.1 wt % to about 10 wt %. In one embodiment, the first solid particulate is present in the downhole treatment composition in the range of from about 0.1 wt % to about 5 wt %. In one embodiment, the first solid particulate is present in the downhole treatment composition in the range of from about 0.1 wt % to about 2.5 wt %. In one embodiment, the first solid particulate is present in the downhole treatment composition in the range of from about 0.1 wt % to about 1 wt %. In one embodiment, the first solid particulate is present in the downhole treatment composition in the range of from about 0.1 wt % to about 0.5 wt %.

The —(C₁₋₆)alkyl-CO— substituents is one kind of acyl substituent or is a combination of acyl substituents. Examples of acyl substituents include acetyl, propionyl, butyryl, pivaloyl, and the like. For example, the cellulose ester can be made of acetyl substituents only, as in Ex 1, 3, and 4. In another example, the cellulose ester can be made from a combination of acetyl and propionyl substituents, as in Ex. 2. Combination of acyl substituents means that the plurality of acyl substituent is made up of more than one acyl substituent. In other words, the substituted cellulose is a mixed cellulose ester made up of more than one acyl groups.

In one embodiment, the degree of substitution of the —(C₁₋₆)alkyl-CO—substituents is in the range of from about 1.9 to about 2.9. In one embodiment, the degree of substitution of the —(C₁₋₆)alkyl-CO— substituents is in the range of from about 2.0 to about 2.5. In one embodiment, the degree of substitution of the —(C₁₋₆)alkyl-CO— substituents is in the range of from about 2.5 to about 3.0. In one embodiment, the degree of substitution of the —(C₁₋₆)alkyl-CO— substituents is in the range of from about 1.7 to about 2.0.

In one embodiment, the downhole diverter composition further comprises (3) a second solid particulate, comprising a second degradable material, wherein the second solid particulate has a second graded particle size in the range of from about 60 to about 100 U.S. Standard Mesh, wherein the first solid particulate exhibits a percent weight loss of not more than about 20 percent (20%) after 4 hours at a temperature in the range of from 127° C. to 250° C. in deionized water, wherein the second degradable material is a second cellulose ester comprising a plurality of (C₁₋₆)alkyl-CO— substituents, wherein the degree of substitution of the (C₁₋₆)alkyl-CO— substituents is in the range of from about 1.7 to about 3.0.

In one class of this embodiment, the degree of substitution of the —(C₁₋₆)alkyl substituents is in the range of from about 1.7 to about 2.0. In one class of this embodiment, the degree of substitution of the —(C₁₋₆)alkyl substituents is in the range of from about 2.0 to about 2.5. In one class of this embodiment, the degree of substitution of the —(C₁₋₆)alkyl substituents is in the range of from about 2.5 to about 3.0.

In one embodiment is a method of well treatment, comprising: (1) injecting any of the previously described well treatment compositions into a downhole formation; (2) allowing the first solid particulate in the composition to form a plug in one or more than one of a perforation, a fracture, and a wellbore in the downhole formation; and (3) performing at least one downhole operation.

In one class of this embodiment, the method further comprises (4) allowing the first particulate material to at least partially degrade.

In one class of this embodiment, the operation is a fracturing operation.

### Experimental Section

The following examples are given to illustrate the compositions and should not be construed as limiting in scope.

### Abbreviations

° C. is degree Celsius, h is hour; DS is degree of substitution; Ac is acetyl; Pr is propionyl; Ex is example;

### EXAMPLE 1

Cellulose Acetate (DS_{Ac}=2.9) Diverting Particulate (Particle Size Distribution 2-2.5 mm). This material can be obtained from Eastman Chemical Company as Eastman™ Cellulose Acetate (VM 149).

### EXAMPLE 2

Cellulose Acetate Propionate (DS_{Ac}=1.3; DS_{Pr}=1.35) Diverting Particulate (Particle Size Distribution 3-3.5 mm). This material can be obtained from Eastman Chemical Company as Eastman™ Cellulose Acetate Propionate (CAP-482-20).

### EXAMPLE 3

Cellulose Acetate (DS_{Ac}=2.5) Diverting Particulate (Particule Size Distribution 2-2.5 mm). This material can be obtained from Eastman Chemical Company as Eastman™ Cellulose Acetate (CA-394-60S).

### EXAMPLE 4

Cellulose Acetate (DSAc=1.9) Diverting Particulate (Particule Size Distribution 3-3.5 mm). This material can be obtained from Eastman Chemical Company as Eastman™ Cellulose Acetate (CA-320S).

Degradation Studies A diverting material should dissolve slowly so that it persists during the simulation treatment. After the treatment, the diverting material should dissolve or disperse in a reasonable amount of time to prevent formation damage and production or injection delays after treatment. (Gomaa, A. M., et al., Experimental Investigation of Particulate Diverter Used to Enhance Fracture Complexity. Society of Petroleum Engineers). Therefore, dissolution tests were performed in closed and static conditions (no agitation) in a high pressure chamber. The initial solid diverter concentration is 0.1 gm in 10 mL deionized water. Dissolution tests were conducted using medium- or fine-mesh-size solid diverter particles. Dissolution experiments were carried out at specified temperatures in deionized water.

Table 1 provides the percent weight loss for Ex 1 and 2 as tested in deionized water at 204° C.

TABLE 1

| | Ex 1 | Ex 2 |
|---|---|---|
| Hours | % wt. loss @ 204.0° C. | % wt loss @ 204.0° C. |
| 8 | 1 | 16 |
| 24 | 15 | 100 |
| 72 | 80 | — |
| 96 | 100 | — |

Table 2 provides the percent weight loss for Ex 1 as tested in deionized water at 149° C. and 166.0° C.

TABLE 2

| | Ex 1 | Ex 1 |
|---|---|---|
| Hours | % wt. loss @ 149.0° C. | % wt. loss @ 166.0° C. |
| 24 | 1 | 2 |
| 72 | 2 | 5 |
| 120 | 4 | 15 |
| 168 | 10 | 26 |
| 240 | 30 | 35 |
| 360 | 70 | 90 |

Table 3 provides the percent weight loss for Ex 3 as tested in deionized water at 149° C. and 166.0° C.

TABLE 3

| | Ex 3 | Ex 3 |
|---|---|---|
| Hours | % wt. loss @ 149.0° C. | % wt. loss @ 166.0° C. |
| 4 | — | 2 |
| 8 | 5 | 5 |
| 24 | 10 | 20 |
| 48 | 20 | 50 |
| 72 | — | 100 |
| 120 | 50 | — |
| 144 | 100 | — |

Table 4 provides the percent weight loss for Ex 4 as tested in deionized water at 127.0° C. and 149.0° C.

TABLE 4

| | Ex 4 | Ex 4 |
|---|---|---|
| Hours | % wt. loss @ 127.0° C. | % wt. @ loss 149.0° C. |
| 4 | 3 | 20 |
| 8 | 5 | 40 |
| 16 | 20 | 100 |
| 24 | 30 | |
| 48 | 50 | |
| 96 | 100 | |

In general, the data show that the rate of weight loss is slower for cellulose esters with a higher degree of substitution of the acyl substituents over cellulose esters with a lower degree of substitution of the acyl substituents. Therefore, the rate of weight loss can be tuned by adjusting the degree of substitution of the cellulose ester or by adjusting the acyl substituents on the cellulose esters.

1. A downhole treatment composition comprising:
(1) a first solid particulate, comprising a first degradable material; and
(2) a base fluid,
wherein the first solid particulate has a first graded particle size in the range of from about 4 to about 8 U.S. Standard Mesh,
wherein the first solid particulate exhibits a percent weight loss of not more than about 20 percent (20%) after 4 hours at a temperature in the range of from 127° C. to 250° C. in deionized water,
wherein the first degradable material is a first cellulose ester comprising a plurality of (C₁₋₆)alkyl-CO— substituents, wherein the degree of substitution of the (C₁₋₆)alkyl-CO— substituents is in the range of from about 1.7 to about 3.0.

2. The composition of claim 1, wherein the first solid particulate exhibits a percent weight loss of not less than sixty-five percent (65%) after 189 hours at a temperature in the range of from 127° C. to 250° C. in deionized water.

3. The composition of claim 1, wherein the base fluid is present in the composition in the range of from about 80 to 99 weight percent based on the total weight of the composition.

4. The composition of claim 1, wherein the composition further comprises proppants.

5. The composition of claim 1, further comprising: (3) a second solid particulate, comprising a second degradable material,
wherein the second solid particulate has a second graded particle size in the range of from about 60 to about 100 U.S. Standard Mesh,
wherein the first solid particulate exhibits a percent weight loss of not more than about 20 percent (20%) after 4 hours at a temperature in the range of from 127° C. to 250° C. in deionized water,
wherein the second degradable material is a second cellulose ester comprising a plurality of (C₁₋₆)alkyl-CO— substituents, wherein the degree of substitution of the (C₁₋₆)alkyl-CO— substituents is in the range of from about 1.8 to about 3.0.

6. The composition of claim 5, wherein the first solid particulate exhibits a percent weight loss of not less than sixty-five percent (65%) after 189 hours at a temperature in the range of from 127° C. to 250° C. in deionized water.

7. The composition of claim 1, wherein each (C₁₋₆)alkyl-CO— is chosen from acetyl, propionyl, or butyryl.

8. The composition of claim 7, wherein each (C₁₋₆)alkyl-CO— is acetyl or a combination of acetyl and propionyl.

9. A method of well treatment, comprising:
(1) injecting the composition of claim 1 into a downhole formation;
(2) allowing the first solid particulate in the composition to form a plug in one or more than one of a perforation, a fracture, and a wellbore in the downhole formation; and
(3) performing at least one downhole operation.

10. The method of claim 9, further comprises: (4) allowing the first particulate material to at least partially degrade.

11. The method of claim 9, wherein the operation is a fracturing operation.

12. The composition of claim 5, wherein each (C₁₋₆)alkyl-CO— is chosen from acetyl, propionyl, or butyryl.

13. The composition of claim 12, wherein each (C₁₋₆)alkyl-CO— is acetyl or a combination of acetyl and propionyl.
